(19) United States
(12) Patent Application Publication
(10) Pub. No.: US 2006/0199648 A1
(43) Pub. Date: Sep. 7, 2006

(54) Gaming machine having convenience platform

(76) Inventors: Michael J. Mitchell, Las Vegas, NV (US); Karl Wudtke, Las Vegas, NV (US); Marvin Hein, Las Vegas, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/074,190

(22) Filed: Mar. 7, 2005

(51) Int. Cl. A63F 13/00

(52) U.S. Cl. 463/46; 463/47

(57) ABSTRACT

A gaming machine having a cabinet comprising at least one convenience platform pivotally and detachably coupled to the cabinet, wherein the convenience platform is movable between a first position and a second position.

### BACKGROUND

Gaming areas in casinos can be crowded as casinos attempt to maximize the number of gaming machines in their gaming areas. Given the high density of gaming machines, there is a limited amount of space around the gaming machine to accommodate a player's personal items or belongings. As a result, players have to hold their personal items or place their items in areas that are less visible and more susceptible to theft.

Accordingly, various types of holders have been developed to accommodate a player's personal items or beverages. While these holders have been useful, these holders use the valuable space on the gaming machine playing surface or expose the player's personal items to passersby and potential theft. Thus, there remains a need for a personal item holder that improves player comfort and efficiently utilizes the available space on a gaming machine.

### SUMMARY

Briefly, and in general terms, various embodiments of a gaming machine having a convenience platform are disclosed herein. The convenience platform is pivotally and detachably coupled to cabinet of the gaming machine, and the convenience platform is movable between a closed position and an open position. The convenience platform can be configured to hold a player's personal items such as, but not limited to, beverages, cellular phones, keys, wallets, cigarettes, lighters, coins, playing chips, or the like. The platform may also provide a fan to cool players during game play, a filtration system to absorb cigarette smoke, or a power outlet to allow the player to charge their electrical device, e.g., cell phones and personal digit assistants (PDA) and the like. The gaming machine may be designed including the convenience platform or the gaming machine may be retrofitted with the convenience platform.

The convenience platform may be detached from the gaming machine and replaced with a variety of different platforms. For instance, one platform may be configured as an ashtray or hold items such as, but not limited to, a cellular phone, pack of cigarettes, gaming chips, or other personal items. In another embodiment, the platform may be configured to include a fan or filtration system to absorb smoke. In yet another embodiment, the platform may be configured to include one or more power outlets, headphone ports, USB ports, Ethernet ports, or other types of Internet connection ports. Furthermore, the convenience platform may include one or more dedicated hooks for hanging a player's personal items.

In use, the convenience platform can be lowered to position where the platform is generally perpendicular to the front of the cabinet. A player may place a beverage or other personal items within the one or more recesses provided on the platform. When in the open position, a player can hang personal items such as, but not limited to, bags and purses onto the platform. When the convenience platform is not in use, the platform may be folded into a position against the front of the cabinet. Additionally, the convenience platform may be detachable and replaced with a different platform via a quick release or other means of rapidly switching between platforms.

In an alternate embodiment, the convenience platform may include a sensor or switch that detects the movement of the platform. When the platform is moved from a closed position to an open position, a signal may be transmitted to casino personnel. Accordingly, casino personnel can frequent the gaming machine to determine whether the player wants to order a drink, needs cigarettes, or other services that may provide the player with a more enjoyable gaming experience.

### BRIEF DESCRIPTION OF THE DRAWINGS

FIG. 1 is a perspective view of one embodiment of a gaming machine having a convenience platform;

FIG. 2 is an enlarged perspective view of the convenience platform of FIG. 1;

FIG. 3 is an enlarged perspective view of a convenience platform having a removable grommet;

FIG. 4 is a perspective view of the convenience platform in a closed position;

FIG. 5 is a perspective view of another embodiment of a convenience platform; and

FIG. 6 is a perspective view of yet another embodiment of a convenience platform.

### DETAILED DESCRIPTION

Various embodiments disclosed herein are directed to gaming machines having an interchangeable convenience platform. Generally, the convenience platform can be configured to hold a player's personal items. In various embodiments, the convenience platform may be provided with fans, lights, power outlets, input ports, or other convenience items. The convenience platform efficiently utilizes the available space on a gaming machine and is intended to improve player comfort and enjoyment while playing the gaming machine.

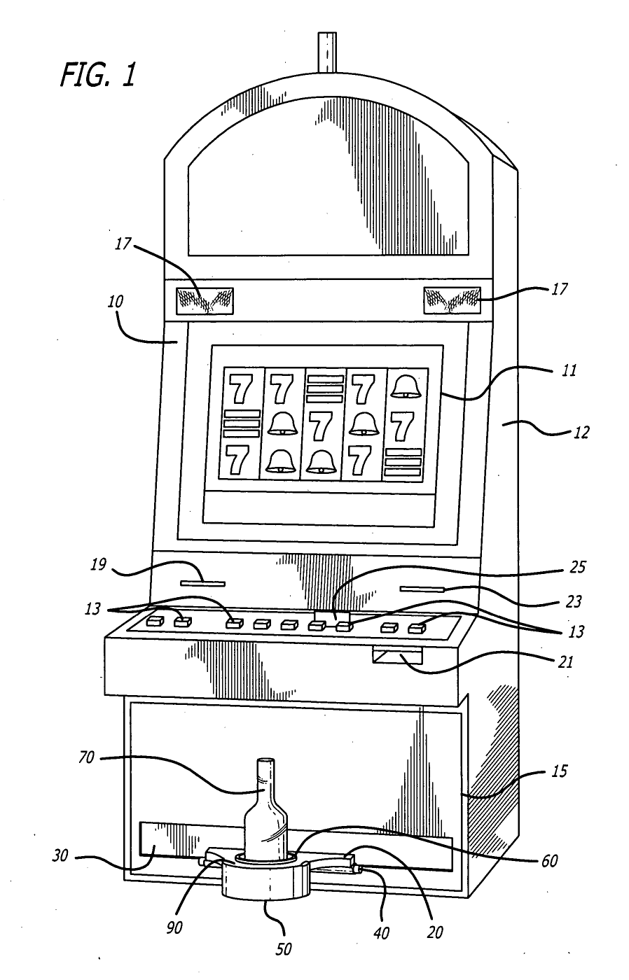

Referring now to the drawings, wherein like reference numerals denote like or corresponding parts throughout the drawings and, more particularly to FIGS. 1-6, there is shown one embodiment of a gaming machine 10 having a convenience platform 20. Specifically, FIG. 1 illustrates one embodiment of a gaming machine 10 having a convenience platform 20. The convenience platform 20 is generally U-shaped platform, but as those skilled in the art will appreciate, the convenience platform 20 may be any shape or size. As those skilled in the art will appreciate, the gaming machine 10 includes a cabinet 12 that houses a display screen 11, game selection buttons 13, speakers 17, a slot for a player tracking card 19, a voucher dispenser 23, a coin-in slot 25, bill/voucher input slot 21, and a convenience platform 20. Of course, one of ordinary skill in the art will appreciate that not all gaming machines 10 will have all these components, and may, indeed, have other components in addition to or in view of those components mentioned here.

In one embodiment, the convenience platform 20 is positioned at the location where a coin tray would be typically located in a traditional gaming machine. In this case, since the gaming machine 10 does not have a coin tray, the gaming machine is generally a cashless gaming machine that does not dispense cash or coin but rather will dispense vouchers or the like that may be redeemed for cash or prizes. Alternatively, the convenience platform 20 may be utilized on a traditional gaming machine 10 having a coin tray, but the platform will need to be modified to fit the cabinet accordingly.

As shown in FIG. 1, the convenience platform 20 is pivotally coupled to the base of a cabinet door 15. In an alternate embodiment, the convenience platform 20 may be coupled directly to the cabinet 12 of the gaming machine 10. The convenience platform 20 is centrally positioned near the base of the cabinet 12 so that the platform is ergonomically suited for either left or right-handed users. In other embodiments, the convenience platform 20 may be positioned at any location on the cabinet 12. In one embodiment, the convenience platform 20 may be moved and fixed in position by an individual. For instance, in one embodiment, the convenience platform 20 includes a through-bore that spans the width of the convenience platform 20, and the platform is slidably mounted on a rod (not shown) that spans across the width of the gaming machine 10. In another embodiment, the convenience platform 20 may include C-shaped clamps that allow the platform to be coupled to the rod (not shown). In various embodiments, the convenience platform 20 may include a locking means to fix the convenience platform along the rod. In another embodiment, the convenience platform 20 may be magnetically mounted to the cabinet 12 of the gaming machine so that the player can position the platform 20 in a desired location.

In another embodiment, the convenience platform 20 may be coupled to the gaming machine cabinet 12 by a back panel 30. The back panel 30 may be coupled to the cabinet 12 with screws or other types of fasteners known or developed in the art. Alternatively, the back panel 30 may be coupled to the cabinet 12 by welding or using adhesives. In another embodiment, the back panel 30 may be integrally formed with the cabinet 12 through molding, casting, or other material formation techniques known or developed in the art.

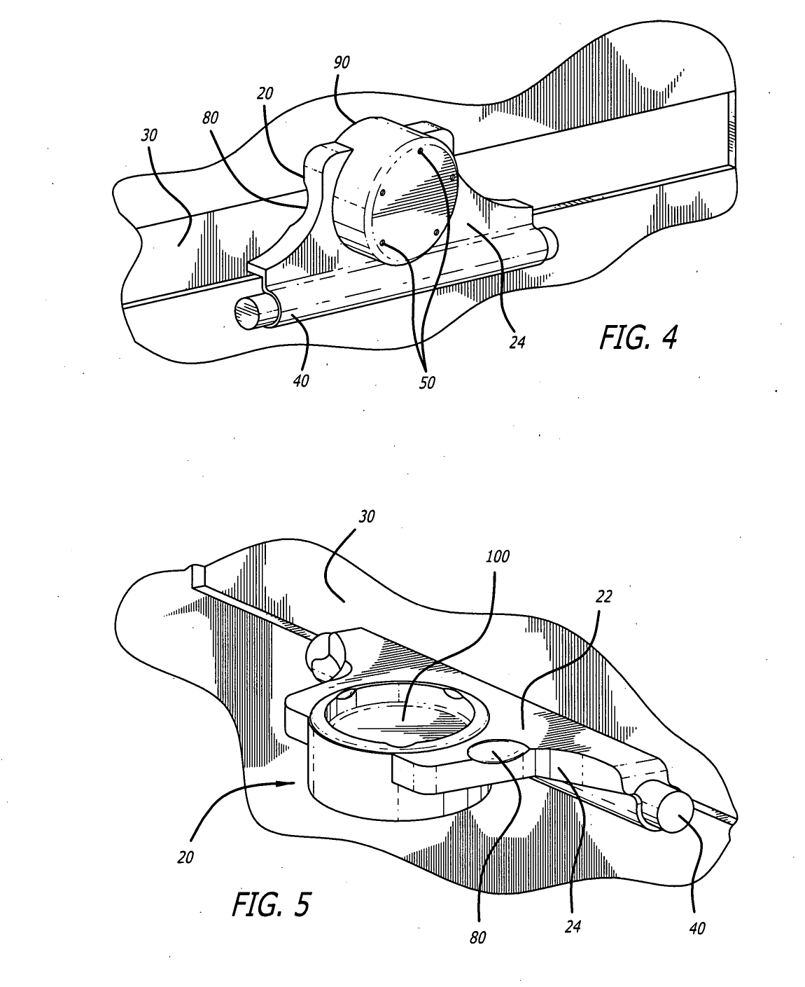

Generally, the convenience platform 20 can be placed in an open position (as shown in FIG. 1) or in a closed position (FIG. 4). In the open position, the convenience platform 20 is substantially perpendicular to cabinet 12. In the closed position, the convenience platform 20 is generally folded against the cabinet 12. In alternative embodiments, the convenience platform 20 can be held in any intermediate position between the open position and the closed position.

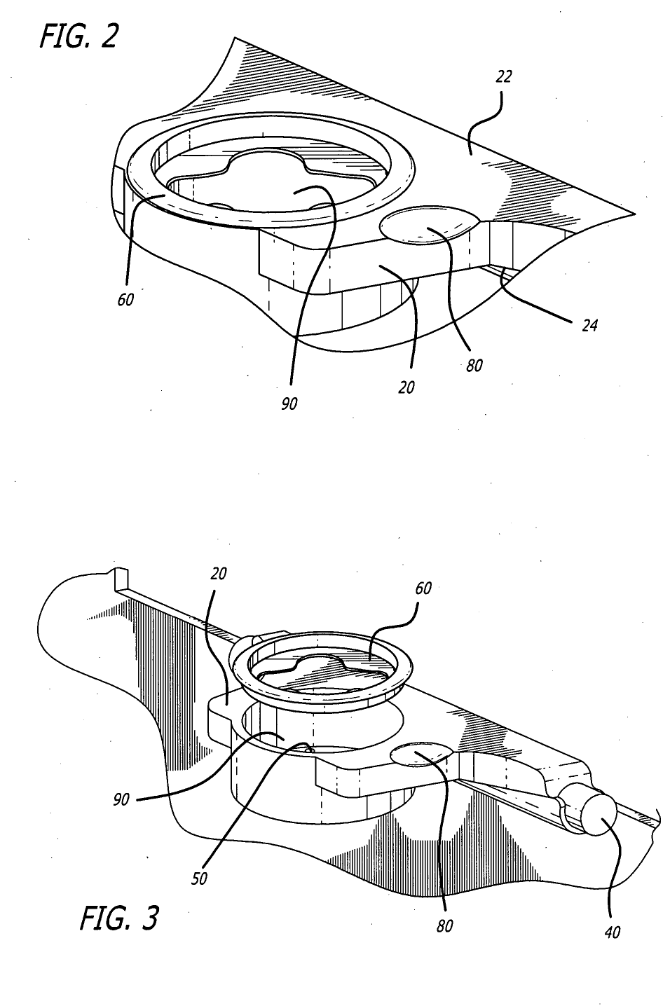

Referring now to FIG. 2, there is shown a convenience platform 20 having an upper surface 22 and a lower surface 24. As shown in FIG. 2, the upper surface 22 and the lower surface 24 are one-piece units, respectively. In alternate embodiments, the upper surface 22 and lower surface 24 can be formed from a plurality of units. In one embodiment, the upper surface 22 is constructed of chrome-plated injection molded plastic or nickel-plated steel. The lower surface 24 may be a less expensive material, such as cast urethane or similar material. As those skilled in the art will appreciate, the convenience platform 20 can be constructed of any suitable material known or developed in the art.

In another embodiment, the upper surface 22 may include a finger grip depression 80 to facilitate moving the convenience platform 20 from a folded-up second position to a first in-use position. As those skilled in the art will appreciate, other similar tabs or handles may be applied to facilitate moving the convenience platform 20 from a folded-up second position to a first in-use position.

As illustrated in FIG. 2, the lower surface 24 includes or defines a beverage container holder 90 having an approximately cylindrical cavity of sufficient size and depth to accommodate a variety of beverage containers. In one embodiment, the beverage container holder 90 has a predetermined diameter and extends vertically between the upper surface 22 and the lower surface 24 of the convenience platform 20. In another embodiment, the beverage container holder 90 has generally tapered walls. The upper portion of the beverage container holder 90 has a greater diameter than the lower portion of the beverage container holder 90. The tapered holding portion provides support for varying sizes of beverage containers 70. In one embodiment, the beverage container holder 90 may include one or more drainage openings 50 located at or near the base of the holder 90.

FIG. 3 illustrates a grommet 60 placed at the top of the beverage container holder 90. With the grommet 60 in place, beverage containers of varying sizes may be snugly retained within the beverage container holder 90. The grommet 60 has a generally circular ring structure having one or more fingers projecting into the opening of the ring. In one embodiment, the grommet 60 may be integral with the beverage container holder 90. In another embodiment, the grommet 60 is removable from the opening of the beverage container holder 90. As those skilled in the art will appreciate, the grommet 60 may be constructed of rubber, ABS plastic, cast urethane, or any other materials known or developed in the art.

FIG. 4 illustrates the convenience platform 20 folded in a closed position against the back plate 30. In the embodiment shown in FIG. 4, the base of the convenience platform 20 includes a logo that may advertise the game theme, game name, casino, or manufacturer of the machine. In another embodiment, the logo may be illuminated with one or more lights. In one embodiment, the convenience platform 20 may be held in the closed position by hinge axle friction, a spring, or other holding means. In use, a player grasps the platform 20 or the finger grip depressions 80 and moves the platform 20 into an open position. In another embodiment, the platform 20 can be automatically folded down into an open position (as shown in FIG. 1). A spring provided in the hinge 40 is configured such that the spring is compressed in a closed position and the spring expands to an open position when the platform 20 is lightly pulled. Conversely, in one embodiment, the convenience platform 20 may move into a closed position when the platform 20 is pushed upward. Movement of the platform 20 may also be controlled by activating a player button which in turn controls a motor or other device which can move the platform from one position to another.

In yet another embodiment, the hinge 40 may include a means for preventing unintentional movement of the convenience platform 20. This may be accomplished by providing an internal spring surrounding a grease axle in the hinge 40. Alternatively, a spring-loaded ball bearing in the hinge 40 can hold the convenience platform 20 in position. In yet another embodiment, a hinge 40 composed of a greased axle, not having a spring, may also prevent the unintentional movement of the convenience platform 20.

Referring back again to FIG. 1, there is shown the convenience platform 20 in an open position and holding a beverage container 70. In one embodiment, a fan or other cooling means (not shown) may be placed in the base of the beverage holder 70 to keep a beverage cool. In another embodiment, a heating plate or other warming means (not shown) may be placed in the base of the beverage holder 70 in order to keep a beverage warm. In alternate embodiments, the convenience platform 20 may be configured to hold one or more beverage containers. It is also contemplated that the convenience platform 20 may include one or more recesses to hold a player's other personal objects such as, but not limited to, cellular phones, keys, wallets, cigarettes, lighters, coins, playing chips, or the like. In yet another embodiment, the convenience platform 20 may also include a light to illuminate the convenience platform 20 and/or the area around the platform.

Additionally, the body of the convenience platform 20 may also be used to hang a player's personal items. That is, a player could place a handbag or any other bag having strapped handles over the convenience platform 20. In this way, the player's bag is positioned in front of the player rather than placed on the floor, next to the gaming machine, or in the individual's lap. Accordingly, a player is provided with a more enjoyable gaming experience because the player is more comfortable and can easily monitor his or her possessions when playing on a gaming machine having a convenience platform 20. This reduces the likelihood of theft of the player's possessions.

In yet another embodiment, the convenience platform 20 may include one or more hooks positioned on the upper or lower surface of the platform 20. The hooks may be used to hold purses, coats, hats, scarves, or the like. In various embodiments, the hooks may be positioned on the convenience platform 20 so that the platform 20 can hold a player's personal items whether the platform 20 is in the open position or in the closed position. In another embodiment, one or more hooks may be provided on the base plate 30 or any portion of the gaming machine cabinet 12.

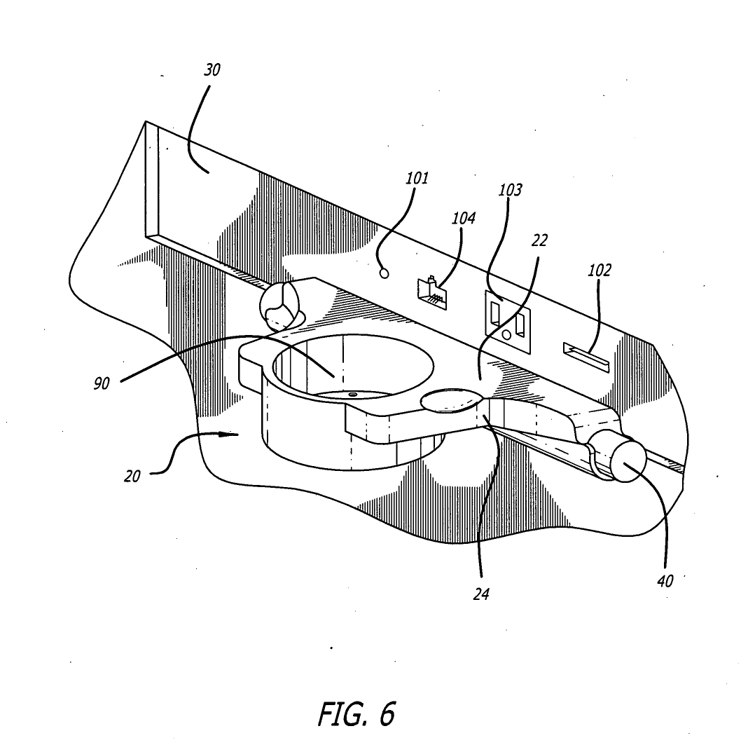

FIG. 5 illustrates another embodiment where the beverage holder recess 90 for the convenience platform 20 is replaced with an ashtray 100. In another embodiment, the convenience platform 20 may include an opening in the shape of an ashtray 100. In yet another embodiment, a removable ashtray (not shown) may be placed within the opening of the container holding recess 90. In these embodiments, the ashtray 100 may be a smokeless ashtray in order to minimize second-hand smoke. In another embodiment, an air purifier (with or without scent capabilities) may be placed in the base of the container holding portion 90. In yet another embodiment, a fan or fume control device (not shown) may be provided in the base of the container holding portion 90. In various embodiments, the fan or fume control device may be activated by a player or when the convenience platform 20 is moved into the open position. Such fan may also be used to cool the players or to warm (if it includes a heating element) the player during game play.

FIG. 6 illustrates another embodiment of the convenience platform 20 and back plate. In this embodiment, one or more ports and/or one or more power outlets are provided on the back plate. In one embodiment, the convenience platform 20 may cover the ports and/or a power outlet when the platform 20 is in a closed position. In another embodiment, the ports or electrical outlets maybe positioned at any location on the back plate. In the various embodiments, the ports may be adapted to accept a headphone port 101, a USB connector 102, an Ethernet port, or other types of internet connection ports. Power outlets are provided to the player to allow the player to charge his personal electronic devices, e.g., cell phones, MP3 players PDA's, or other similar devices.

In another embodiment, the convenience platform 20 may be an interchangeable platform. That is, the convenience platform 20 may include a quick release or other means for rapidly detaching and exchanging or switching between convenience platforms 20. Accordingly, in use, the convenience platforms 20 may be removed for cleaning or replaced if the platform 20 is damaged. Alternatively, the convenience platform 20 may be switched for a different type of platform 20, if required by player or casino demand.

In yet another embodiment, the convenience platform 20 includes a sensing means (not shown) such as, but not limited to, a switch or a sensor. The switch detects the movement of the convenience platform 20 from a closed position to an open position. Once the platform 20 is in the open position, a signal is sent to casino personnel via a signaling means. In one embodiment, the signaling means is a light positioned on top of the gaming machine. In other embodiments, the signaling means may be a radiofrequency signal, an infrared signal, a text message, an e-mail, an instant message, or other signaling means known or developed in the art. In another embodiment, the switch may have a sensor to detect the type of convenience platform 20 (e.g., beverage holder or ashtray) that is being used by a gaming patron. In yet another embodiment, the signaling means may periodically transmit a signal to casino personnel.

In use, casino personnel will be notified that a player is at a particular machine when moving the convenience platform 20 from a closed position to an open position. Optionally, the sensor may be able to detect the type of convenience platform 20 and convey this information to casino personnel. For instance, if the convenience platform 20 is a beverage tray, casino personnel will be notified that a gaming patron is drinking, interested in drinking, or may need another drink. Alternatively, if the convenience platform 20 includes an ashtray, casino personnel may frequent the gaming machine to periodically empty the ashtray or provide smoking products to the gaming patron at the gaming machine. Accordingly, the gaming patron can be provided with beverages or the like thereby inducing a patron to continue to play the gaming machine.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming machine, comprising:
a cabinet comprising at least one convenience platform pivotally and detachably coupled to the cabinet, wherein the convenience platform is movable between at least a first position and a second position.

2. The gaming machine of claim 1, wherein the convenience platform is pivotally coupled to a base plate that replaces a coin tray of the gaming machine.

3. The gaming machine of claim 1, wherein the convenience platform defines at least one recess sized to hold a beverage or a player's personal items.

4. The gaming machine of claim 3, wherein at least one recess has tapering walls.

5. The gaming machine of claim 1, wherein the convenience platform further comprises one or more detents positioned about the periphery of the convenience platform, wherein the tabs facilitate the movement of the convenience platform between the first position and the second position.

6. The gaming machine of claim 3, wherein one recess is an ashtray.

7. The gaming machine of claim 6, wherein the ashtray is a smoke-less ashtray.

8. The gaming machine of claim 3, wherein at least one recess includes a fan, an air purifier, or an air freshener.

9. The gaming machine of claim 2, wherein at least one hook is coupled to the convenience platform, the base plate, the cabinet, or a combination thereof.

10. The gaming machine of claim 2, wherein the base plate includes at least one USB port, at least one power outlet, at least one Ethernet port, at least one internet connection, at least one headphone port, or a combination thereof.

11. The gaming machine of claim 3, further comprising a sensor for detecting the movement of the convenience platform from the first position to the second position.

12. The gaming machine of claim 11, further comprising a means for signaling the movement of the convenience platform from the first position to the second position, wherein the signaling means is in communication with the sensor.

13. The gaming machine of claim 12, wherein the signaling means is a light positioned on top of the cabinet, a radiofrequency signal, or an infrared signal.

14. The gaming machine of claim 1, wherein the convenience platform is movable and capable of being fixed at any position along the width of the cabinet.

15. The gaming machine of claim 1, wherein the convenience platform is magnetically mounted to the cabinet.

16. A gaming machine, comprising:
a convenience platform pivotally and detachably coupled to a gaming machine cabinet, wherein the convenience platform comprises one or more recesses and is movable between at least an open position and a closed position;
a sensor for detecting the movement of the convenience platform from the closed position to the open position; and
a means for signaling the movement of the convenience platform, wherein the signaling means is in communication with the sensor.

17. The gaming machine of claim 16, wherein the at least one recess is in the shape of an ashtray or is sized to hold a beverage or a player's personal items.

18. The gaming machine of claim 16, further comprising at least one USB port, at least one power outlet, at least one Ethernet port, at least one internet connection, at least one headphone port, or a combination thereof.

19. A method of monitoring use of a gaming machine, comprising:
providing a gaming machine having a convenience platform;
sensing the movement of the convenience platform from a closed position to an open position; and
transmitting a signal to a casino personnel that the gaming machine is occupied.

20. The method of claim 19, wherein the signal is a light positioned on top of the cabinet, a radiofrequency signal, an infrared signal, a text message, an e-mail, an instant message, or the like.

21. The method of claim 20, further comprising periodically transmitting a signal to the casino personnel.
